(19) United States
(12) Patent Application Publication
(10) Pub. No.: US 2025/0373006 A1
(43) Pub. Date: Dec. 4, 2025

(54) DEVICE AND METHOD FOR PROTECTING AN ELECTRICAL POWER SUPPLY GRID AND FOR AUTOMATING AND CONTROLLING COMPONENTS OF AN ELECTRICAL APPARATUS

(71) Applicant: Siemens Aktiengesellschaft, München (DE)

(72) Inventors: Matthias Reis, Berlin (DE); Dirk Sommer, Berlin (DE)

(21) Appl. No.: 19/223,332

(22) Filed: May 30, 2025

(30) Foreign Application Priority Data
May 30, 2024 (EP) 24178991.6

(51) Int. Cl. H02H 7/22; H02H 1/00; H02J 3/00

(52) U.S. Cl. CPC H02H 7/22; H02H 1/0092; H02J 3/001

(57) ABSTRACT

A device for protecting an electrical power supply grid and for automating and controlling components of a substation, includes at least two intelligent electronic devices (IEDs) networked to one another and each connected via a preprocessing unit to at least one measuring sensor each configured to record a measured variable characterizing the state of the electrical power supply grid at a measuring point of a power supply grid. The preprocessing unit is connected to the measuring sensors at the input and is configured to transfer measured values provided at the output to at least one IED. Each IED is configured to perform predefined protection, control and/or automation functions (PCAFs). Orchestration software provides an orchestration method that dynamically distributes the PCAFs among the IEDs based on a leader election method, to make the device more cost-effective and simultaneously able to be operated with a high level of reliability.

### CROSS-REFERENCE TO RELATED APPLICATION

This application claims the priority, under 35 U.S.C. § 119, of European Patent Application EP 24178991.6, filed May 30, 2024; the prior application is herewith incorporated by reference in its entirety.

### FIELD AND BACKGROUND OF THE INVENTION

The invention relates to a device for protecting an electrical power supply grid and for automating and controlling components of an electrical apparatus with at least two IEDs that are networked to one another and are each connected via a preprocessing unit to at least one measuring sensor that in each case is configured to record a measured variable, which characterizes the state of the electrical power supply grid, at a measuring point of a power supply grid, wherein the preprocessing unit is connected to the measuring sensors at the input and is configured to transfer measured values provided at the output to at least one IED, and wherein the IED is configured to perform predefined protection, control and/or automation functions (PCAFs).

Such a device is already known from the prior art. By way of example, substations, as an electrical apparatus, have protection and automation devices. The protection devices are connected to measuring sensors that record a measured variable, which characterizes the electrical power supply grid, at a measuring point of the electrical power supply grid, for example at an output. Digital measured values are generated from the measured variable, for example a current or a voltage, and are monitored by protection algorithms for the presence of a fault condition. If there is a fault condition, a fault signal is generated and transferred to a circuit breaker that disconnects the faulty section of the electrical power supply grid from the remaining part of the electrical power supply grid. Furthermore, previously known protection devices monitor items of equipment such as transformers, for example, against the effects of faults such as ground faults or short circuits. That makes it possible to prevent damage to personnel or components of the substation. Automation devices control substation components such as disconnectors and switching devices, for example.

In addition to substations, power plants are also taken into consideration as an electrical apparatus. However, this list is by no means conclusive.

That results in the requirement to continuously monitor currents and voltages in the phase conductors of the electrical power supply and all other relevant items of equipment as reliably as possible. At the same time, there are economic boundary conditions such that a maximum level of reliability of the protection must be achieved, wherein the purchase, operation and maintenance of the protection devices and components necessary therefor should be as cost-effective as possible at the same time.

FIG. 1 shows a previously known device of an electrical power supply grid that is not illustrated in the figures. The device 1 includes a plurality of so-called intelligent electronic devices, which are hereinafter referred to as IEDs 2a, 2b, 2c, 2d, 2e, 2f and 2g. Each IED 2 is connected to at least one measuring sensor 3. The IED 2e is configured to protect a busbar. The IED 2f, on the other hand, is used to protect a transformer that is not illustrated in the figures. In this case, so-called differential protection takes effect, in which both the currents flowing into the transformer and the currents flowing out of it are measured. Two current transformers 3 are provided for recording those currents. If the difference between the measured values recorded in a time-synchronized manner is not equal to zero, there may be a fault.

The IEDs 2 shown in FIG. 1 are connected to one another and to an interface 5 of the substation 1 via a process bus 4. The interface 5 of the substation is in turn connected to a remote control center 6.

Decentralized protection algorithms, such as overcurrent time protection, are executed on devices with direct access to the current and voltage transformers. In other words, such IEDs have a measuring transducer input. Separate devices are required for centralized functions such as the busbar protection or the substation communication gateway. The assignment of an IED to a specific protection, control and/or automation function (PCAF) is stipulated statically within a classic digitized substation. That static assignment makes the monitoring of the electrical power supply grid or the automation of the substation components complex and costly.

### SUMMARY OF THE INVENTION

It is accordingly an object of the invention to provide a device and a method for protecting an electrical power supply grid and for automating and controlling components of an electrical apparatus, which overcome the hereinafore-mentioned disadvantages of the heretofore-known devices and methods of this general type and which improve the device and method so that they are more cost-effective and at the same time able to be operated with a high level of reliability.

With the foregoing and other objects in view there is provided, in accordance with the invention, a method which uses orchestration software that provides an orchestration method that dynamically distributes the PCAFs among the IEDs on the basis of a leader election method.

The dynamic distribution of the protection, control and automation functions (PCAFs) among the IEDs increases the reliability of the device, since the failure of a particular IED does not necessarily mean the failure of a PCAF. Rather, the dynamic redistribution of the PCAF from a faulty IED to an IED that is fully functional makes it possible to maintain the effects of the PCAFs. The so-called leader election method is used for the specific selection of an IED for a particular PCAF. Methods of this type are known to a person skilled in the art.

In order to be able to carry out the leader election method, all IEDs advantageously have a so-called orchestrator. The orchestrator is a software function. Each IED receives a list of available orchestrators and decides which orchestrator is to be addressed in accordance with a load balancing method. A load balancing method is also able to be implemented, for example, by random selection. All orchestrators synchronize their data version with one another, for example, using a so-called raft consensus algorithm.

The PCAFs require a certain amount of time to restart on a functional IED after failing on a failed IED. For PCAFs having a failure which is able to be tolerated for a limited period of time, such a PCAF can simply be restarted on a functional IED after the failure of an IED. The orchestrator selects the IED for the new instance in accordance with a scoring method. The score is calculated from various criteria, such as, for example, available working memory, free CPU capacity or the like. If two IEDs have an identical score, a random generator is used to decide which IED is eventually selected.

For PCAFs having a failure which is not able to be tolerated for a limited period of time, the orchestrator must generate at least two instances of the PCAF that run on at least two IEDs. In this case, specific redundancy concepts are used for the PCAFs.

The measuring sensors are advantageously in the form of voltage and/or current transformers, wherein each IED has an input for a current transformer and an input for a voltage transformer. In this advantageous further development, the measuring sensors, the voltage or current transformers, continuously record the measured variables and provide an analog measurement signal at the output. The analog measurement signal is transferred to the input of the IEDs. The IEDs have an internal preprocessing unit, which may also be referred to as a merging unit. This merging unit samples the analog measurement signals to obtain samples or measured values and then digitizes the measured values, which are then present in digital form. The preprocessing unit may be installed in an IED or provided as a separate component.

Advantageously, each IED has an input and an output for a process bus, via which the IEDs are connected to one another. The process bus is used to exchange measured values, as is required in differential protection, for example.

In the case of a development that is expedient in this regard, the measured value recording is carried out in a time-synchronized manner. This is necessary, for example, for phasor measured values, wherein, in addition to the amplitude of the respective current, its exact phase angle also becomes important. Time-synchronized recording of measured values is also required for busbar protection.

In one of the preferred configurations of the invention, the IEDs are at least partially connected to one another via a station control bus, wherein the dynamic exchange of the PCAFs takes place via the station control bus. A station control bus differs from a process bus in terms of the speed of the data line. Significantly higher demands are placed on the process bus than on a station control bus.

Each IED preferably has a binary input and a binary output. The binary inputs and outputs are used to switch a switch, for example a circuit breaker.

The IEDs advantageously have a CPU with more than 4000 MIPS in relation to the Dhrystone benchmark. The IEDs must have a processor with a sufficient performance that is able to be characterized using the Dhrystone benchmark.

With the objects of the invention in view, there is concomitantly provided a method for protecting an electrical power supply grid and for automating and controlling processes or components of a substation, comprising the steps of:
recording a measured variable, which characterizes the state of the electrical power supply grid, at a plurality of measuring points by way of measuring sensors that provide measurement signals,
transferring the measurement signals to at least one preprocessing unit,
generating digital measured values from the measurement signals by way of the preprocessing unit, and
transmitting the digital measured values to at least one IED, wherein the IEDs perform protection, control and automation functions (PCAFs).

Proceeding from this previously known method, the invention is based on the object of improving that method so that it may be carried out cost-effectively and at the same time with a high level of reliability.

The invention achieves this object by virtue of dynamically distributing the PCAFs among the IEDs using an orchestration method.

The advantages of the method according to the invention have already been explained in detail above in connection with the device according to the invention. These explanations are correspondingly applicable here.

Other features which are considered as characteristic for the invention are set forth in the appended claims.

Although the invention is illustrated and described herein as embodied in a device and a method for protecting an electrical power supply grid and for automating and controlling components of an electrical apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings wherein identical reference signs indicate identically acting components.

### BRIEF DESCRIPTION OF THE FIGURES

FIG. 1 is a block diagram of a device according to the prior art;

FIG. 2 is a block diagram of an exemplary embodiment of a device according to the invention; and

FIG. 3 is a block diagram of a further embodiment of a device according to the invention.

### DETAILED DESCRIPTION OF THE INVENTION

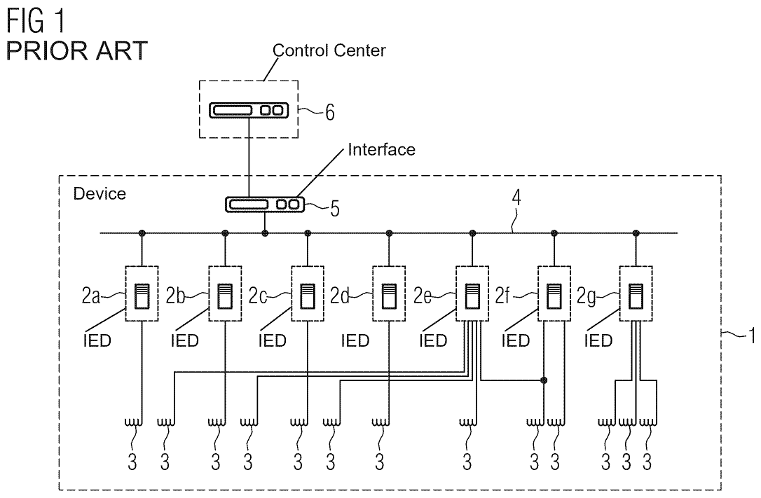

Referring now in detail to the figures of the drawings, it is seen that FIG. 1 has already been explained above in connection with the discussion of the prior art.

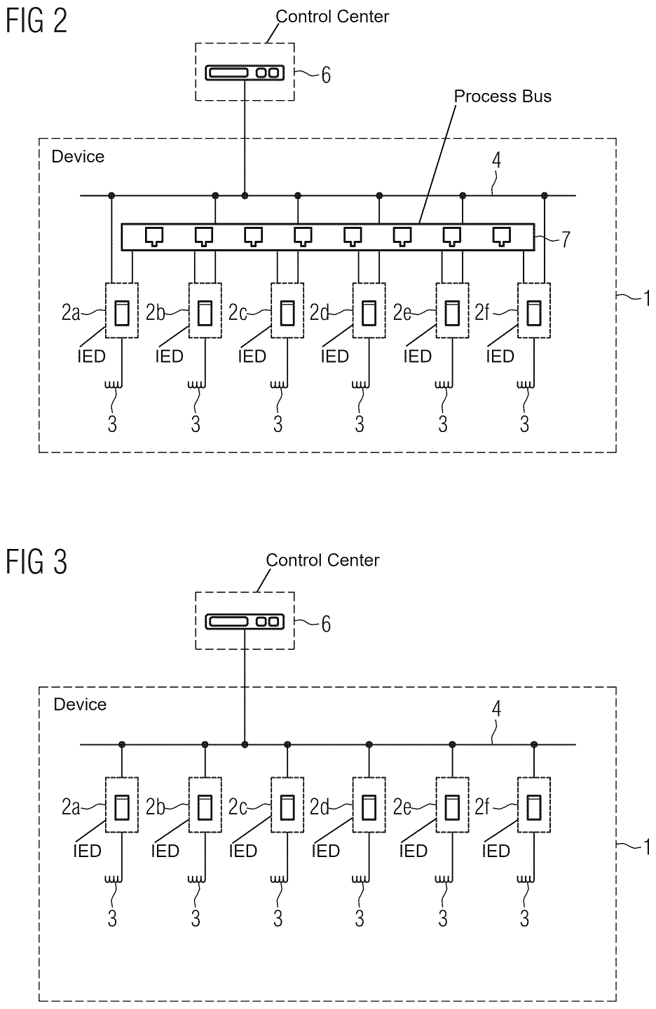

FIG. 2 shows an exemplary embodiment of the device 1 according to the invention. The device 1 has IEDs, i.e. intelligent electronic devices 2a, 2b, 2c, 2d, 2e and 2f that are connected to one another via a process bus 7 and via a station control bus 4. The IEDs 2 each have a measuring transducer input, via which the respective IED is connected to a current or voltage transformer 3. As already described in connection with FIG. 1, the measuring transducers 3 provide analog measured values, such as current or voltage, at the output, which are sampled by the IED in a time-synchronized manner to obtain samples or measured values. The measured values are then digitized so that digital measured values are present. The digital measured values obtained are combined to form data telegrams by the preprocessing unit (merging unit) installed in the IED, wherein the data telegrams include both an amplitude and a phase angle. In other words, phasor measured values are provided. The data telegrams are exchanged with the other IEDs via the process bus 7.

Furthermore, the IEDs are also connected to one another via the station control bus 4. The PCAF functions are also exchanged via this station control bus 4 in accordance with the method described above.

FIG. 3 represents a further exemplary embodiment of the device according to the invention. The exemplary embodiment shown in FIG. 3 differs from the exemplary embodiment shown in FIG. 2 in that only a station control bus 4 is provided, whereas the process bus 7 is missing. In other words, the IEDs 2 are able to perform only decentralized protection functions. The IEDs 2 are in turn each equipped with a converter input, in which they are connected to a current or voltage transformer 3. The device 1 according to the invention is connected to a control center 6 via the station control bus 4, as in the exemplary embodiment according to FIG. 2.

1. A device for protecting an electrical power supply grid and for automating and controlling components of an electrical apparatus, the device comprising:
at least one measuring sensor configured to record a measured variable characterizing a state of the electrical power supply grid at a measuring point of the electrical power supply grid;
at least two intelligent electronic devices being networked to one another, each of said at least two intelligent electronic devices configured to perform at least one of predefined protection, control or automation functions;
preprocessing units associated with said at least two intelligent electronic devices, said preprocessing units connecting each of said at least two intelligent electronic devices to said at least one measuring sensor;
said preprocessing units each having an input connected to said at least one measuring sensor and an output configured to transfer measured values to at least one of said at least two intelligent electronic devices; and
orchestration software providing an orchestration method dynamically distributing the at least one of predefined protection, control or automation functions among said at least two intelligent electronic devices based on a leader election method.

2. The device according to claim 1, wherein said at least one measuring sensor includes a plurality of measuring sensors configured to record at least one of a voltage prevailing in the electrical power supply grid or a current flowing in the electrical power supply grid.

3. The device according to claim 1, which further comprises a process bus for networking said at least two intelligent electronic devices to one another, each of said at least two intelligent electronic devices having an output to be connected to said process bus, and each of said at least two intelligent electronic devices having an input.

4. The device according to claim 1, which further comprises a station bus, each of said at least two intelligent electronic devices having an output to be connected to said station bus, and each of said at least two intelligent electronic devices having an input.

5. The device according to claim 1, wherein said preprocessing units are configured to generate synchronized measured values.

6. The device according to claim 1, wherein each of said at least two intelligent electronic devices has a binary input and output.

7. The device according to claim 1, wherein a plurality of said at least two intelligent electronic devices have a CPU with more than 4000 MIPS compared to the Dhrystone benchmark.

8. A method for protecting an electrical power supply grid and for automating and controlling components of a substation, the method comprising the following steps:
using measuring sensors providing measurement signals to record a measured variable characterizing a state of the electrical power supply grid at a plurality of measuring points;
transferring the measurement signals to at least one preprocessing unit;
using the at least one preprocessing unit to generate digital measured values from the measurement signals;
transmitting the measured values to at least one intelligent electronic device, the at least one intelligent electronic device performing protection, control and automation functions; and
dynamically distributing the protection, control and automation functions among the at least one intelligent electronic device by using an orchestration method.
